(19) United States
(12) Patent Application Publication
(10) Pub. No.: US 2018/0324048 A1
(43) Pub. Date: Nov. 8, 2018

(54) SMART ORDER APPARATUS, OPERATION METHOD THEREOF, AND TERMINAL

(71) Applicant: SK Planet Co., Ltd., Seongnam-si (KR)

(72) Inventor: Joon Sung Lee, Seongnam-si (KR)

(73) Assignee: SK Planet Co., Ltd.

(21) Appl. No.: 15/973,743

(22) Filed: May 8, 2018

(30) Foreign Application Priority Data
May 8, 2017 (KR) 10-2017-0057320

(51) Int. Cl. H04L 12/24; H04W 48/10; H04W 60/04

(52) U.S. Cl. CPC H04L 41/0889; H04W 84/12; H04W 60/04; H04W 48/10

(57) ABSTRACT

The present disclosure relates to a smart order device, an operation method thereof, and a terminal, in which signal processing is performed in a broadcasting manner between the smart order device and the terminal in a state in which the operation mode of the smart order device is maintained, in a process of user configuration required for use of a smart order device based on an IoT device implemented to enable instant product purchasing by means of only a button input. Therefore, the present disclosure can remarkably shorten the time required for the user configuration and thus can enhance the user's satisfaction.

### CROSS-REFERENCE TO RELATED APPLICATIONS

The present application claims priority to Korean Patent Application No. 10-2017-0057320, filed on May, 8, 2017, which is incorporated herein by reference in its entirety.

### TECHNICAL FIELD

The present disclosure relates to a smart order device based on an Internet-of-Things (IoT) device for instant purchasing of a product through only a button input, and relates to a solution for simplifying a process for user configuration required for use of the smart order device.

### BACKGROUND

The statements in this section merely provide background information related to the present disclosure and may not constitute prior art.

It is a recent trend that business operators of global commerce services, such as Amazon or Alibaba, are not only enlarging or strengthening company competence through rapid shipment of products including perishable foods, but also expanding the purchase channels to an office or a home using an IoT device, such as Echo or Dash.

With this trend, it is necessary to actively utilize an IoT device as a means for providing a new purchase experience in order to secure customer's loyalty and strengthening the competence for a particular product category.

In this regard, an IoT device (hereinafter, referred to as “smart order device”) implemented to enable instant purchasing of a product through only a button input has been recently released in the market in order to meet the necessity described above.

As described above, the smart order device is implemented to enable on-line purchasing of a product through only a button input, and thus provides a user with a new purchasing experience and convenience of purchasing.

However, in order to use a conventional smart order device, it is necessary to perform a user configuration process, such as a paring between the smart order device and a terminal having a corresponding applications installed therein. As a result, a user must wait for long time before being able to actually use the smart order device.

### SUMMARY

The present disclosure has been made in view of the above circumstances, and an aspect of the present disclosure is to simplify a user configuration procedure required for use of an IoT device-based smart order device implemented to enable instant purchasing of a product through only a button input.

In view of the above aspects, a smart order device according to an embodiment of the present disclosure may include: a processor configured to perform a process for device registration in a service server; and a memory configured to store at least one command executed by the processor wherein the at least one command includes: an acquisition command configured to, in response to a request for device registration for the smart order device, acquire access information of a wireless relay device and access information of the service server from a terminal transmission signal transmitted from a terminal; a transmission command configured to transmit device transmission signal including device identification information of the smart order device to enable the terminal, which identifies the device identification information of the smart order device from the device transmission signal, to pre-process device registration for the smart order device in the service server; and a process command configured to completely process device registration for the smart order device by accessing the wireless relay device based on the access information of the wireless relay device and by accessing the service server, through the wireless relay device, based on the access information of the service server.

More specifically, the acquisition command may be configured to set the operation mode of the smart order device into a standby mode at a Station-Access Point (STA-AP) to enable the access information of the wireless relay device to be acquired from the terminal transmission signal, and the process command may be configured to set the operation mode of the smart order device into an access mode at the STA-AP to enable an access to the wireless relay device.

More specifically, at least one of the terminal transmission signal and the device transmission signal may include a User Datagram Protocol (UDP) signal transmitted in a broadcasting manner.

More specifically, in pre-processing of the device registration for the smart order device, terminal identification information of the terminal may be mapped to device identification information of the smart order device, and the mapped information may be then registered in the service server.

More specifically, the process command may be configured to transmit the access information of the wireless relay device to the service server through the wireless relay device.

More specifically, in completing the device registration for the smart order device, the service server determines whether the device identification information mapped to terminal identification information of the terminal coincides with the device identification information of the smart order device received from the smart order device according to the process command.

In view of the above aspects, a terminal according to an embodiment of the present disclosure may include: a processor configured to perform a process associated with a smart order device; and a memory configured to store at least one command executed by the processor, wherein the at least one command includes: a transmission command configured to, when device registration for the smart order device is required, transmit a terminal transmission signal to enable a smart order device to acquire access information of the wireless relay device and access information of the service server from the terminal transmission signal; and a process command configured to identify device identification information of the smart order device from a device transmission signal received from the smart order device receiving the terminal transmission signal, and pre-process the device registration for the smart order device in the service server.

More specifically, the terminal transmission signal may include a UDP signal transmitted in a broadcasting manner, and the smart order device may acquire the access information of the wireless relay device from the terminal transmission signal in a standby mode at a Station-Access Point (STA-AP).

In view of the above aspects, an operation method of a smart order device according to an embodiment of the present disclosure may include: acquiring access information of a wireless relay device and access information of a service server from a terminal transmission signal transmitted from a terminal; transmitting device transmission signal including device identification information of the smart order device to enable the terminal, which identifies the device identification information of the smart order device from the device transmission signal, to pre-process device registration for the smart order device in the service server; and completely processing device registration for the smart order device by accessing the wireless relay device based on the access information of the wireless relay device and by accessing the service server, through the wireless relay device, based on the access information of the service server.

More specifically, the acquiring may include setting the operation mode of the smart order device into a standby mode at an STA-AP to acquire the access information of the wireless relay device from the terminal transmission signal, and the completely processing may include setting the operation mode of the smart order device into an access mode at the STA-AP and accessing the wireless relay device.

More specifically, at least one of the terminal transmission signal and the device transmission signal may include a User Datagram Protocol (UDP) signal transmitted in a broadcasting manner.

More specifically, in pre-processing of the device registration for the smart order device, terminal identification information of the terminal may be mapped to device identification information of the smart order device, and the mapped information may be then registered in the service server.

More specifically, the processing may include transmitting the access information of the wireless relay device to the service server through the wireless relay device.

More specifically, the completely processing may include determining, by the service server, whether the device identification information mapped to terminal identification information of the terminal coincides with the device identification information of the smart order device received from the smart order device.

In a smart order device, an operation method thereof, and a terminal according to an embodiment of the present disclosure, signal processing is performed in a broadcasting manner between a smart order device and a terminal in a state in which the operation mode of the smart order device is maintained, in a process of user configuration required for use of the smart order device based on an IoT device implemented to enable instant product purchasing by means of only a button input. Therefore, the present disclosure can remarkably shorten the time required for the user configuration and thus can enhance the user's satisfaction.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram illustrating a smart order system according to an embodiment of the present disclosure;

FIG. 2 illustrates an example for explaining a user configuration process in a conventional smart order device;

FIG. 3 is a schematic block diagram of a smart order device according to an embodiment of the present disclosure;

FIG. 4 is a view illustrating a user configuration process in a smart order device according to an embodiment of the present disclosure;

FIG. 5 illustrates an example of a hardware system for implementing a smart order device according to an embodiment of the present disclosure;

FIG. 6 is a schematic block diagram of a terminal according to an embodiment of the present disclosure;

FIG. 7 illustrates an example of a hardware system for implementing a terminal according to an embodiment of the present disclosure;

FIG. 8 is a signal flow diagram illustrating an operation flow in a smart order system according to an embodiment of the present disclosure;

FIG. 9 is a flowchart illustrating an operation flow in a smart order device according to an embodiment of the present disclosure; and

FIG. 10 is a flowchart illustrating an operation flow in a terminal according to an embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It should be noted that the technical terms in the specification are merely used for describing a specific embodiment but do not limit the scope of the present disclosure. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present disclosure, the technical term should be replaced with the correct technical term which can be understood by those skilled in the art. Further, the general terms used in the present disclosure should be interpreted in the context according to the dictionary definition and should not be construed as possessing an excessively limited meaning.

Hereinafter, exemplary embodiments of the present disclosure will be described in detail with reference to the accompanying drawings, equal or similar elements are assigned an equal reference numeral, and an overlapping description thereof will be omitted. Further, in the following description of the present disclosure, a detailed description of known technologies incorporated herein will be omitted when it may make the subject matter of the present disclosure rather unclear. Further, it should be noted that the accompanying drawings are intended only for the easy understanding of the technical idea of the present disclosure, and the spirit of the present disclosure should not be construed as being limited by the accompanying drawings. In addition to the accompanying drawings, the spirit of the present disclosure should be construed to cover all modifications, equivalents, and alternatives thereof.

Hereinafter, an embodiment of the present disclosure will be described with reference to the accompanying drawings.

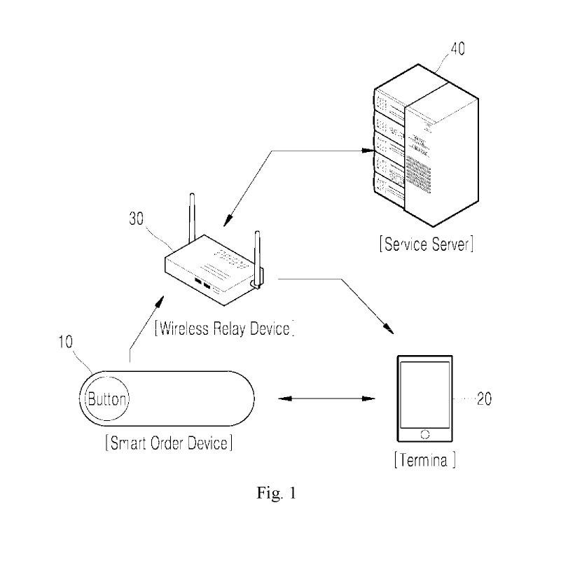

FIG. 1 is a view illustrating a smart order system according to an embodiment of the present disclosure.

As illustrated in FIG. 1, a smart order system according to an embodiment of the present disclosure may include a smart order device 10, a terminal 20, a wireless relay device 30, and a service server 40.

The smart order device 10 refers to an IoT device implemented to support instant purchasing of a product, and may send a request for instant product purchasing to the service server 40 when a user request (request for instant product purchasing), such as button input, is identified.

The smart order device 10 supports and enables pre-configured instant purchasing of a product even without user's active operation, such as access to the service server 40 through terminal 20, logging-in, product inquiry, ordering, or settlement.

The terminal 20 refers to a terminal in which an application associated with a product purchase service is installed, and may be used for product inquiry, product ordering, or delivery inquiry, separately from, for example, an instant product purchase service and user configuration for use of the smart order device 10, through various User Interfaces (UIs) provided by the application.

The terminal 20 may be, for example, a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an ultrabook, a wearable device (including, for example, a watch-type terminal (smartwatch), a glass-type terminal (smart glass), and a Head Mounted Display (HMD)), a Wibro terminal, an Internet Protocol Television (IPTV) terminal, a smart TV, a digital broadcasting terminal, a television, a 3D television, a home theater system, an Audio Video Navigation (AVN) terminal, an Audio/Video (A/V) system, or a flexible terminal, and may include all devices in which an application not limited thereby can be installed.

The wireless relay device 30 refers to a device providing a wireless access environment (e.g., Wi-Fi) allowing the smart order device 10 and the terminal 20 to access the service server 40 and may be implemented by, for example, an Access Point (AP).

The service server 40 refers to a server configured to provide a service for instant purchasing of a product requested by the smart order device 10, and identifies a product mapped or set in device identification information (e.g., MAC or serial number) of the smart order device 10 and processes payment for and delivery of the product without user's active operation, in response to a request for instant purchasing of the product from the smart order device 10.

However, for the instant purchasing of a product, in association with device identification information (e.g., MAC, serial, etc.) of the smart order device 10, it is required that information including the product, a payment means, a delivery destination, etc. be previously mapped and registered in the service server 40.

The service server 40 may be implemented in the form of a web server, a database server, or a proxy server, may include one or more programs installed therein among various software programs enabling a network load distribution mechanism or service device to operate on the Internet or another network, and may be implemented as a computerized system through the programs. Further, the network may be an http network, a dedicated network using private lines, an intra-net, or another type of network. Further, in order to protect data from an attack from a hacker or a third party, components of an advertisement providing system according to an embodiment of the present disclosure may be connected through a security network. The service server 40 may include a plurality of database servers, and may be implemented by a method in which the database servers are connected with the smart order device 10 and the user terminal 20 through a predetermined type network connection including a distributed database server architecture.

Through the configuration described above, the smart order system according to an embodiment of the present disclosure enables instant product purchasing using the smart order device 10.

Meanwhile, for instant product purchasing using the smart order device 10, configuration of a user for using the smart order device 10 is necessary, and this can be understood as a process of registering the smart order device 10 in the service server 40 in order to use the smart order device 10.

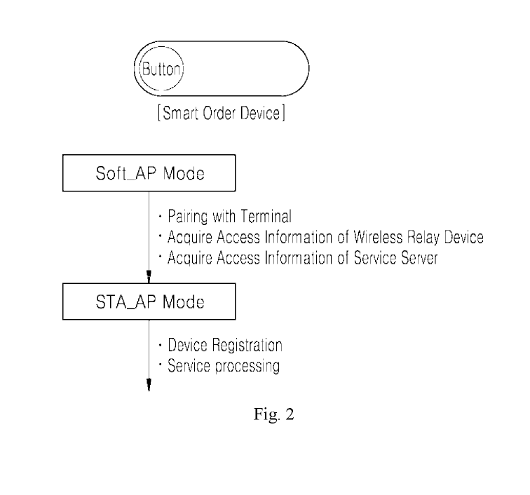

In this regard, FIG. 2 schematically shows a conventional procedure for registering the smart order device 10 in the service server 40.

As illustrated in FIG. 2, in order to register the smart order device 10 in the service server 40 in the conventional way, it is inevitable that pairing for connection between the smart order device 10 and the terminal 20 should be established in advance after the smart order device 10 is configured into a Software enabled Access Point (Soft-AP) mode. After connecting with the terminal 20, the smart order device 10 acquires access information of the wireless relay device 30 and the access information of the service server 40 from the terminal 20.

Further, for device registration for the smart order device 10, the smart order device 10 is required to switch its operation mode from the Software enabled Access Point (Soft-AP) mode into a Station-Access Point (STA-AP) mode. Only after the operation mode of the smart order device 10 is switched into the Station-Access Point (STA-AP) mode, registration of the smart order device into the service server 40 and processing of an instant product purchase service thereafter can be performed.

As noted from the above description, procedures including paring between the smart order device 10 and the terminal 20 and operation mode switching configuration of the smart order device 10 are indispensable in order to use the smart order device 10 in the conventional way, and these procedures require a long elapse of time before use of the smart order device 10. Moreover, user's active operation is required for the operation mode switching and the pairing of the smart order device 10.

Therefore, an embodiment of the present disclosure proposes a scheme capable of simplifying a user configuration procedure required for use of the smart order device 10, and elements of a smart order system configured to implement the scheme will be described in more detail hereinafter.

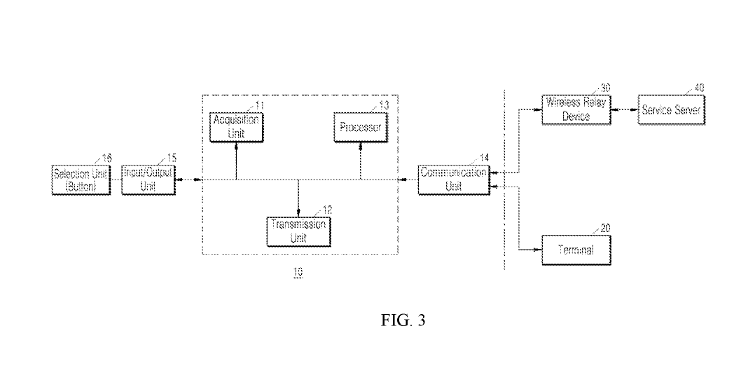

FIG. 3 is a block diagram illustrating a schematic configuration of a smart order device 10 according to an embodiment of the present disclosure.

As illustrated in FIG. 3, the smart order device 10 according to an embodiment of the present disclosure may include an acquisition unit 11 configured to acquire access information from a terminal transmission signal, a transmission unit 12 configured to transmit a device transmission signal, and a processor 13 configured to process device registration.

The entirety or at least a part of the configuration of the smart order device 10 including the acquisition unit 11, the transmission unit 12, and the processor 13 may be implemented in the form of a hardware module or a software module executed by a processor, or may be in the form in which a software module and a hardware module are combined.

The smart order device 10 according to an embodiment of the present disclosure may further include a communication unit 14 configured to support communication with the terminal 20 and the service server 40, and an input/output unit 15 and a selection unit 16 configured to enable identifying of a user request for instant product purchasing.

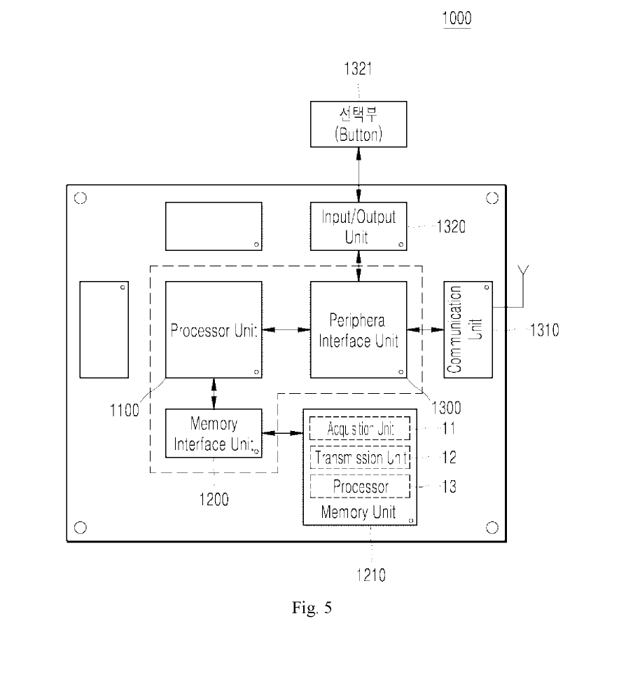

The configurations of the communication unit 14, the input/output unit 15, and the selection unit 16 correspond to the configurations of a communication unit 1310, an input/output unit 1320, and an selection unit 1321, which will be described later with reference to FIG. 5, so a more detailed description thereof will be given later.

The smart order device 10 according to an embodiment of the present disclosure may process the user configuration associated with the terminal 20 through the core configuration including the acquisition unit 11, the transmission unit 12, and the processor 13. Hereinafter, each element of the core configuration of the smart order device 10 will be discussed in more detail.

The acquisition unit 11 functions to identify access information from a signal transmitted from a terminal.

More specifically, in response to a request for device registration relating to the smart order device 10, the acquisition unit 11 acquires access information (e.g., SSID and PW) of the wireless relay device 30 and access information (e.g., IP and port) of the service server 40 from a terminal transmission signal received from the terminal 20.

The terminal transmission signal refers to a User Datagram Protocol (UDP) signal transmitted from the terminal 20 in a broadcasting manner.

The acquisition unit 11 configures the operation mode of the smart order device 10 into a standby mode (listen mode) at a Station-Access Point (STA-AP) in order to receive the terminal transmission signal as described above. Then, the acquisition unit receives the terminal transmission signal broadcasted from the terminal 20 and acquires access information (e.g., SSID and PW) of the wireless relay device 30 and access information (e.g., IP and port) of the service server 40 from the received terminal transmission signal.

In this regard, when it is identified that device registration for the smart order device 10 is required, the terminal 20 may transmit, in a broadcasting manner, a terminal transmission signal including access information (e.g., SSID and PW) of the wireless relay device 30 and access information (e.g., IP and port) of the service server 40.

Here, whether device registration for the smart order device 10 is required may be determined by identifying user's selection on a User Interface (UI) provided by an application of the terminal 20.

In the above description of the embodiment of the present disclosure, both access information (e.g., SSID and PW) of the wireless relay device 30 and access information (e.g., IP and port) of the service server 40 are acquired from one terminal transmission signal. However, it is natural that access information (e.g., SSID and PW) of the wireless relay device 30 and access information of the service server 40 may be acquired from separate terminal transmission signals, respectively.

The transmission unit 12 performs a function of transmitting a terminal transmission signal.

More specifically, when the access information (e.g., SSID and PW) of the wireless relay device 30 and the access information (e.g., IP and port) of the service server 40 are identified from the terminal transmission signal, the transmission unit 12 transmits a device transmission signal including device identification information (MAC or serial No.) of the smart order device 10 to enable the terminal 20 having received the device transmission signal to previously process device registration for the smart order device 10 in the service server 40.

Like the terminal transmission signal, the device transmission signal refers to a UDP signal transmitted in a broadcasting manner.

When receiving a device transmission signal broadcasted from the smart order device 10, the terminal 20 obtains device identification information (MAC or serial No.) of the smart order device 10 from the device transmission signal, maps terminal identification information (e.g., APP ID) of the terminal 20 to the obtained device identification information (MAC or serial No.) of the smart order device 10, and registers the mapped information in the service server 40. In this way, the terminal may pre-process device registration for the smart order device 10.

When the pre-processing of device registration for the smart order device 10 is completed, the terminal 20 may notify the smart order device 10, through a separate terminal transmission signal, that pre-processing of device registration for the smart order device 10 has been completed.

The processor 13 functions to complete device registration for the smart order device 10.

More specifically, when transmission of the device transmission signal is completed, the processor 13 accesses the wireless relay device 30 using the access information (e.g., SSID and PW) of the wireless relay device 30 and accesses the service server 40 through the wireless relay device 30, using the access information (e.g., IP and port) of the service server 40, so as to complete the device registration for the smart order device 10.

Specifically, the processor 13 may configure the operation mode of the smart order device 10 into an access mode at an STA-AP, so as to access the wireless relay device 30 and complete the device registration.

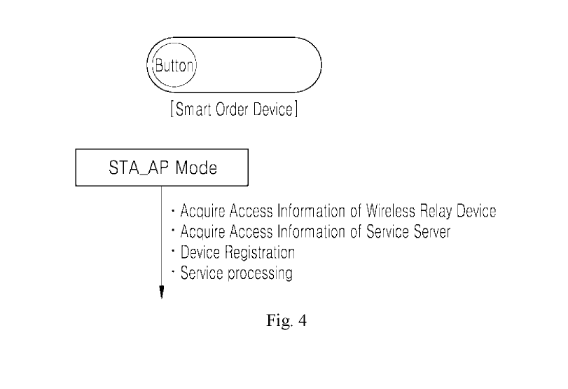

It should be noted that, as shown in FIG. 4, the operation mode of the smart order device 10 is maintained in the STA-AP mode from the reception of the terminal transmission signal to the completion of the device registration according to an embodiment of the present disclosure, and this corresponds to a difference from the prior art which requires switching of the operation mode of the smart order device 10 between the Software enabled Access Point (Soft-AP) mode and the STA-AP mode, for device registration for the smart order device 10.

Further, the processor 13 transmits the device identification information (MAC or serial No.) of the smart order device 10 to the service server 40, to enable the service server 40 to complete device registration by determining whether the device identification information (MAC or serial No.) of the smart order device 10 received from the smart order device 10 coincides with the device identification information mapped and registered in the terminal identification information of the terminal 20 according to the pre-processing of device registration.

When the device registration for the smart order device 10 is completed, the service server 40 may notify the smart order device 10 through the wireless relay device 30 that the device registration has been completed.

When a user request (button input) through the selection unit 16 is identified after the device registration for the smart order device 10 is completed, the processor 13 transmits an instant product purchase request including the device identification information (MAC or serial No.) of the smart order device 10 to the service server 40, to enable the service server 40 to process instant product purchasing including purchase, payment, and delivery of a product mapped to the device identification information (MAC or serial No.) of the smart order device 10.

As already described above, the elements within the smart order device 10 may be implemented in the form of a hardware module or a software module executed by a processor, or may be in the form in which a software module and a hardware module are combined.

The form of a hardware module or a software module executed by a processor, or the form in which a software module and a hardware module are combined may be implemented by an actual hardware system (e.g., computer system).

Hereinafter, a hardware system 1000 for implementing a smart order device 10 according to an embodiment of the present disclosure will be described with reference to FIG. 5.

For reference, it should be noted that, although the elements of the smart order device 10 in the example described above are implemented in the hardware system 1000, the elements and the operations thereof may be different from those in an actual system.

As illustrated in FIG. 5, a hardware system 1000 according to an embodiment of the present disclosure may include a processor unit 1100, a memory interface unit 1200, and a peripheral interface unit 1300.

Each element of the hardware 1000 as described above either may be an individual element or may be connected to one or more integrated circuits, and the elements may be combined by a bus system (not shown).

The bus system corresponds to an abstraction which indicates multi-drop or point-to-point connections, communication lines/interfaces, and/or one or more predetermined physical buses connected by proper bridges, adaptors, and/or controllers.

In order to enable the hardware system to perform various functions, the processor unit 1100 communicates with the memory unit 1210 through the memory interface unit 1200 to execute various software modules stored in the memory unit 1210.

In the memory unit 1210, the acquisition unit 11, the transmission unit 12, and the processor 13, which are core elements within the smart order device 10 described above with reference to FIG. 3, may be stored in the form of a software (application) module, and another Operating System (OS) may be additionally stored.

An operating system (e.g., in the case of an embedded operating system, such as I-OS, Android, Darwin, RTXC, LINUX, UNIX, OS X, WINDOWS, or VxWorks) includes various procedures, instruction sets, software components and/or drivers configured to control and manage general system jobs (e.g., memory management, storage device control, power management, etc.), and functions to facilitate communication between various hardware modules and software modules.

For reference, the memory unit 1210 includes a cache, a main memory, and a secondary memory. However, the memory unit may include a memory hierarchical structure not limited thereby, wherein the memory hierarchical structure may be implemented by a predetermined combination of a RAM (e.g., SRAM, DRAM, and DDRAM), a ROM, a FLASH, a magnetic and/or optical storage device (e.g., disc drive, magnetic tape, compact disk (CD), and digital video disc (DVD)).

The peripheral interface unit 1300 enables communication between the processor unit 1100 and a peripheral device.

The peripheral device is used to provide a different function to the hardware system 1000, and may include, for example, a communication unit 1310 and an input/output unit 1320 in one embodiment of the present disclosure.

The communication unit 1310 functions to provide a communication function for communication with another device. To this end, the communication unit includes, for example, an antenna system, an RF transceiver, at least one amplifier, a tuner, at least one oscillator, a digital signal processor, a CODEC chip-set, and a memory. However, the communication unit is not limited thereto and may include a known circuit configured to perform those functions.

Communication protocols supported by the communication unit 1310 as described above include, for example, a Wireless LAN (WLAN), a Digital Living Network Alliance (DLNA), a Wireless Broadband (Wibro), a World Interoperability for Microwave Access (Wimax), a Global System for Mobile communication (GSM), a Code Division Multi Access (CDMA), a Code Division Multi Access 2000 (CDMA2000), an Enhanced Voice-Data Optimized or Enhanced Voice-Data Only (EV-DO), a Wideband CDMA (WCDMA), a High Speed Downlink Packet Access (HSDPA), a High Speed Uplink Packet Access (HSUPA), an Institute of Electrical and Electronics Engineers (IEEE) 802.16, a Long Term Evolution (LTE), a Long Term Evolution-Advanced (LTE-A), a Wireless Mobile Broadband Service (WMBS), a Bluetooth, a Radio Frequency Identification (RFID), an Infrared Data Association (IrDA) communication, an Ultra-Wideband (UWB) communication, a ZigBee communication, a Near Field Communication (NFC), an Ultra Sound Communication (USC), a Visible Light Communication (VLC), a Wi-Fi communication, and a Wi-Fi Direct communication. Further, wired communication networks may include all of a wired Local Area Network (LAN), a wired Wide Area Network (WAN), a Power Line Communication (PLC), a USB communication, an Ethernet communication, a serial communication, and an optical/coaxial cable communication, and may include, without being limited thereto, all protocols capable of providing a communication environment for communication with another device.

Further, the input/output unit 1320 functions as a controller for controlling an I/O device interworking with another hardware system, and may perform a function of identifying an input of a selection unit 1321 corresponding to a button.

Therefore, the elements of the smart order device 10 stored in the form of software modules in the memory unit 1210 interwork with the communication unit 1310 and the input/output unit 1320 by means of the memory interface unit 1200 and the peripheral device interface unit 1300 in the form of commands executed by the processor unit 1100, so as to process user configuration associated with the terminal 20.

Hereinafter, for better understanding of the present disclosure, the elements of the smart order device 10 will be described with reference to FIG. 5, in association with the hardware system 1000.

First, the acquisition unit 11 functions to identify access information from a signal transmitted from a terminal.

More specifically, in response to a request for device registration for the smart order device 10, the acquisition unit 11 acquires access information (e.g., SSID and PW) of the wireless relay device 30 and access information (e.g., IP and port) of the service server 40 from a terminal transmission signal received from the terminal 20 through the communication unit 1310 and transfers the acquired information to the transmission unit 12 and the processor 13, respectively.

The terminal transmission signal is a UDP signal and is transmitted from the terminal 20 in the broadcasting manner.

The acquisition unit 11 configures the operation mode of the smart order device 10 into a standby mode (listen mode) at a Station-Access Point (STA-AP) in order to receive the terminal transmission signal as described above. Then, the acquisition unit receives the terminal transmission signal broadcasted from the terminal 20 and acquires access information (e.g., SSID and PW) of the wireless relay device 30 and access information (e.g., IP and port) of the service server 40 from the received terminal transmission signal.

The transmission unit 12 performs a function of transmitting a device transmission signal.

More specifically, when receiving a result identifying the access information (e.g., SSID and PW) of the wireless relay device 30 and the access information (e.g., IP and port) of the service server 40 from the terminal transmission signal, the transmission unit 12 may transmit, through the communication unit 1310, a device transmission signal including device identification information (MAC or serial No.) of the smart order device 10 to enable the terminal 20 having received the device transmission signal to previously process device registration for the smart order device 10 in the service server 40.

The device transmission signal is a UDP signal and is transmitted in the broadcasting manner.

The processor 13 functions to complete device registration for the smart order device 10.

More specifically, when it is identified, from the transmission unit 12, that transmission of the device transmission signal has been completed, the processor 13 accesses the wireless relay device 30 using the access information (e.g., SSID and PW) of the wireless relay device 30 through the communication unit 1310, and accesses the service server 40 through the wireless relay device 30, using the access information (e.g., IP and port) of the service server 40, so as to complete the device registration for the smart order device 10.

Specifically, the processor 13 may configure the operation mode of the smart order device 10 into an access mode at an STA-AP, so as to access the wireless relay device 30 and complete the device registration.

Specifically, the processor 13 transmits the device identification information (MAC or serial No.) of the smart order device 10 to the service server 40, to enable the service server 40 to complete device registration by determining whether the device identification information (MAC or serial No.) of the smart order device 10 received from the smart order device 10 coincides with the device identification information mapped and registered in the terminal identification information of the terminal 20 according to the pre-processing of device registration.

When a user request (button input) through the selection unit 16 is identified through the input/output unit 1320 after the device registration for the smart order device 10 is completed, the processor 13 transmits an instant product purchase request including the device identification information (MAC or serial No.) of the smart order device 10 to the service server 40 through the communication unit 1310, to enable the service server 40 to process instant product purchasing including purchase, payment, and delivery of a product mapped to the device identification information (MAC or serial No.) of the smart order device 10.

Subsequent to the above description relating to the smart order device 10 according to an embodiment of the present disclosure, the terminal 20 will be described hereinafter.

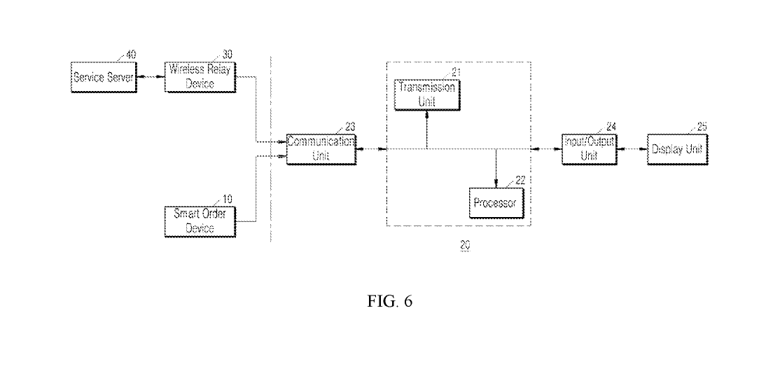

FIG. 6 is a block diagram illustrating a schematic configuration of a terminal 20 according to an embodiment of the present disclosure.

As illustrated in FIG. 6, the terminal 20 according to an embodiment of the present disclosure may include a transmission unit 21 configured to transmit a terminal transmission signal and a processor 22 configured to process device registration.

The entirety or at least a part of the configuration of the terminal 20 including the transmission unit 21, and the processor 22 may be implemented in the form of a hardware module or a software module executed by a processor, or may be in the form in which a software module and a hardware module are combined.

In addition to the above-described configuration, the terminal 20 according to an embodiment of the present disclosure may include a communication unit 23 configured to support communication with the smart order device 10 and the service server 40, and an input/output unit 24 and a display unit 25 configured to enable identifying of user configuration.

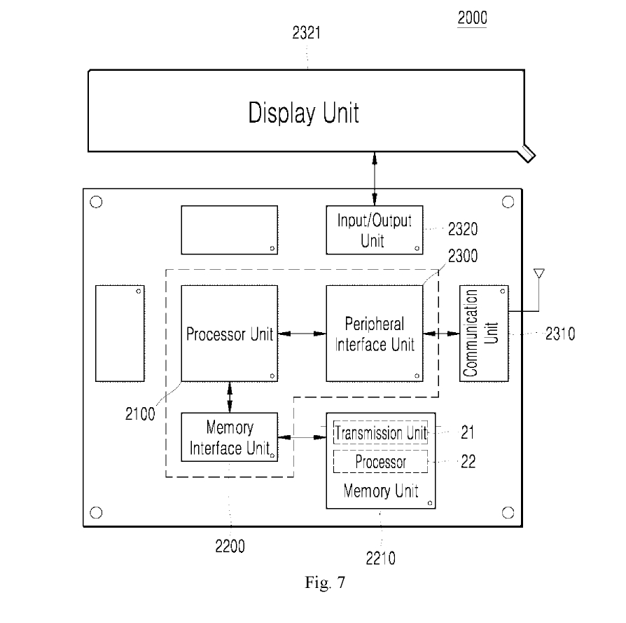

The configurations of the communication unit 23, the input/output unit 24, and the display unit 25 correspond to the configurations of a communication unit 2310, an input/output unit 2320, and a display unit 2321, which will be described later with reference to FIG. 7, so a more detailed description thereof will be given later.

The terminal 20 according to an embodiment of the present disclosure may process the user configuration associated with the smart order device 10 through the core configuration including the transmission unit 21 and the processor 22. Hereinafter, each element of the core configuration of the terminal 20 will be discussed in more detail.

The transmission unit 21 performs a function of transmitting a terminal transmission signal.

Specifically, when it is identified that device registration for the smart order device 10 is required, the transmission unit 21 transmits a terminal transmission signal including access information (e.g., SSID and PW) of the wireless relay device 30 and access information (e.g., IP and port) of the service server 40.

The transmission unit 21 transmits the terminal transmission signal, which is a UDP signal, in the broadcasting manner.

In this regard, the smart order device 10 may configure the operation mode of the smart order device 10 into a standby mode (listen mode) at a Station-Access Point (STA-AP) in order to receive the terminal transmission signal as described above. Then, the smart order device may receive the terminal transmission signal broadcasted from the terminal 20 and acquire access information (e.g., SSID and PW) of the wireless relay device 30 and access information (e.g., IP and port) of the service server 40 from the received terminal transmission signal.

The processor 22 functions to pre-process device registration for the smart order device 10.

More specifically, after the terminal transmission signal is transmitted, when device identification information (MAC or serial No.) of the smart order device 10 is identified from the device transmission signal received from the smart order device 10, the processor 22 pre-processes device registration for the smart order device 10.

When receiving a device transmission signal broadcasted from the smart order device 10, the processor 22 obtains device identification information (MAC or serial No.) of the smart order device 10 from the device transmission signal, maps terminal identification information (e.g., APP ID) of the terminal 20 to the obtained device identification information (MAC or serial No.) of the smart order device 10, and registers the mapped information in the service server 40. In this way, the terminal may pre-process device registration for the smart order device 10.

When the pre-processing of device registration for the smart order device 10 is completed, the processor 22 may notify the smart order device 10, through a separate terminal transmission signal, that pre-processing of device registration for the smart order device 10 has been completed.

In this regard, when the access information (e.g., SSID and PW) of the wireless relay device 30 and the access information (e.g., IP and port) of the service server 40 are identified from the terminal transmission signal, the smart order device 10 transmits a device transmission signal including device identification information (MAC or serial No.) of the smart order device 10 to enable the terminal 20 having received the device transmission signal to previously process device registration for the smart order device 10 in the service server 40.

Like the terminal transmission signal, the device transmission signal refers to a UDP signal transmitted in a broadcasting manner.

Further, when transmission of the device transmission signal is completed, the smart order device 10 accesses the wireless relay device 30 using the access information (e.g., SSID and PW) of the wireless relay device 30 and accesses the service server 40 through the wireless relay device 30, using the access information (e.g., IP and port) of the service server 40, so as to complete the device registration.

As already described above, the elements within the terminal 20 may be implemented in the form of a hardware module or a software module executed by a processor, or may be in the form in which a software module and a hardware module are combined.

The form of a hardware module or a software module executed by a processor, or the form in which a software module and a hardware module are combined may be implemented by an actual hardware system (e.g., computer system).

Hereinafter, a hardware system 2000 implementing the elements of the terminal 20 according to an embodiment of the present disclosure will be described with reference to FIG. 7.

Among the elements of the hardware system 2000 illustrated in FIG. 7, elements having the same names as those of the hardware system 1000 described above with reference to FIG. 5 may be considered to be the same, so a detailed description of the same elements will not be repeated.

As illustrated in FIG. 7, the hardware system 2000 for implementing the terminal 20 according to an embodiment of the present disclosure may include a processor unit 2100, a memory interface unit 2200, and a peripheral interface unit 2300.

In order to enable the hardware system to perform various functions, the processor unit 2100 communicates with the memory unit 2210 through the memory interface unit 2200 to execute various software modules stored in the memory unit 2210.

In the memory unit 2210, the transmission unit 21 and the processor 22, which are core elements within the terminal 20 described above with reference to FIG. 6, may be stored in the form of a software (application) module, and another operating system may be additionally stored.

The peripheral interface unit 2300 enables communication between the processor unit 2100 and a peripheral device.

The peripheral device is used to provide a different function to the hardware system 2000, and may include, for example, a communication unit 2310 and an input/output unit 2320 in one embodiment of the present disclosure.

The communication unit 2310 functions to provide a communication function for communication with another device. To this end, the communication unit includes, for example, an antenna system, an RF transceiver, at least one amplifier, a tuner, at least one oscillator, a digital signal processor, a CODEC chip-set, and a memory. However, the communication unit is not limited thereto and may include a known circuit configured to perform those functions.

Further, the input/output unit 1320 functions as a controller for controlling an I/O device interworking with another hardware system, and may perform a function of controlling the display unit 2321 configured to display a UI of an application in an embodiment of the present disclosure.

It is natural that the display unit 2321 supports a touch interface for identification of a request for device registration on the UI.

The display unit 2321 as described above may implemented by, for example, a Liquid Crystal Display (LCD), A Thin Film Transistor LCD (TFT-LCD), a Light Emitting Diode (LED), an Organic LED (OLED), an Active Matrix OLED (AMOLED), a retina display, a flexible display, and 3-dimensional display.

Therefore, the elements of the terminal 20 stored in the form of software modules in the memory unit 2210 communicate with the communication unit 2310 and the input/output unit 2320 by means of the memory interface unit 2100 and the peripheral device interface unit 2300 in the form of commands executed by the processor unit 2100, so as to process user configuration associated with the smart order device 10.

Hereinafter, for better understanding of the present disclosure, the elements of the terminal 20 will be described with reference to FIG. 7, in association with the hardware system 2000.

The transmission unit 21 performs a function of transmitting a terminal transmission signal.

Specifically, when it is identified, through the display unit 2321 and the input/output unit 2320, that device registration for the smart order device 10 is required, the transmission unit 21 transmits, through the communication unit 2310, a terminal transmission signal including access information (e.g., SSID and PW) of the wireless relay device 30 and access information (e.g., IP and port) of the service server 40.

The transmission unit 21 transmits the terminal transmission signal, which is a UDP signal, in the broadcasting manner.

In this regard, the smart order device 10 may configure the operation mode of the smart order device 10 into a standby mode (listen mode) at a Station-Access Point (STA-AP) in order to receive the terminal transmission signal as described above. Then, the smart order device may receive the terminal transmission signal broadcasted from the terminal 20 and acquire access information (e.g., SSID and PW) of the wireless relay device 30 and access information (e.g., IP and port) of the service server 40 from the received terminal transmission signal.

The processor 22 functions to pre-process device registration for the smart order device 10.

More specifically, after the terminal transmission signal is transmitted, when device identification information (MAC or serial No.) of the smart order device 10 is identified from the device transmission signal received from the smart order device 10 through the communication unit 2310, the processor 22 pre-processes device registration for the smart order device 10.

When receiving a device transmission signal broadcasted from the smart order device 10, the processor 22 obtains device identification information (MAC or serial No.) of the smart order device 10 from the device transmission signal, maps terminal identification information (e.g., APP ID) of the terminal 20 to the obtained device identification information (MAC or serial No.) of the smart order device 10, and registers the mapped information in the service server 40. In this way, the terminal may pre-process device registration for the smart order device 10.

In this regard, when the access information (e.g., SSID and PW) of the wireless relay device 30 and the access information (e.g., IP and port) of the service server 40 are identified from the terminal transmission signal, the smart order device 10 transmits a device transmission signal including device identification information (MAC or serial No.) of the smart order device 10 to enable the terminal 20 having received the device transmission signal to previously process device registration for the smart order device 10 in the service server 40.

Like the terminal transmission signal, the device transmission signal refers to a UDP signal transmitted in a broadcasting manner.

Further, when transmission of the device transmission signal is completed, the smart order device 10 accesses the wireless relay device 30 using the access information (e.g., SSID and PW) of the wireless relay device 30 and accesses the service server 40 through the wireless relay device 30, using the access information (e.g., IP and port) of the service server 40, so as to complete the device registration.

As noted from the above discussion, in a process of user configuration required for use of a smart order device 10 based on an IoT device implemented to enable instant product purchasing by means of only a button input, the configurations within a smart order system according to an embodiment of the present disclosure can perform signal processing in a broadcasting manner between the smart order device 10 and the terminal 20 in a state in which the operation mode of the smart order device is maintained. Therefore, the present disclosure can remarkably shorten the time required for the user configuration and thus can enhance the user's satisfaction.

Hereinafter, a smart order system according to an embodiment of the present disclosure and a flow of operations of elements of the system will be described.

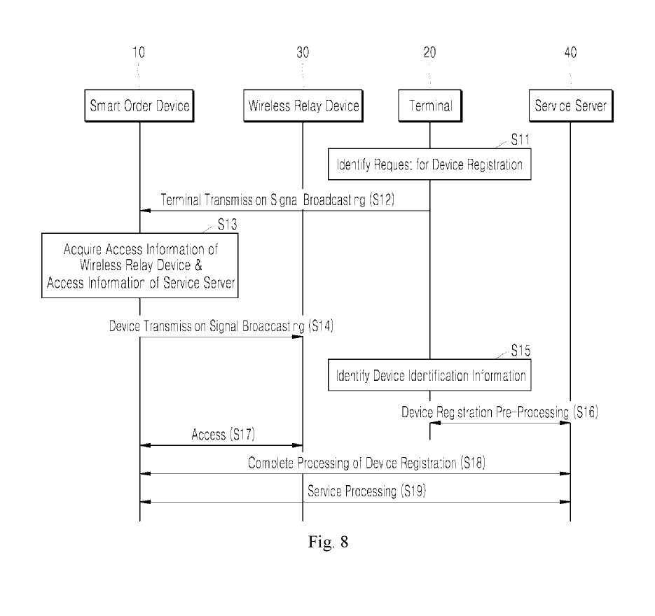

FIG. 8 is a signal flow diagram illustrating an operation flow in a smart order system according to an embodiment of the present disclosure.

First, when it is identified in operation S11 that device registration for the smart order device 10 is required, the terminal 20 transmits a terminal transmission signal including access information (e.g., SSID and PW) of the wireless relay device 30 and access information (e.g., IP and port) of the service server 40 in operation S12.

The transmission unit 21 transmits the terminal transmission signal, which is a UDP signal, in the broadcasting manner.

Then, in operation S13, the smart order device 10 acquires access information (e.g., SSID and PW) of the wireless relay device 30 and access information (e.g., IP and port) of the service server 40 from the terminal transmission signal received from the terminal 20.

Specifically, the smart order device 10 may configure the operation mode of the smart order device 10 into a standby mode (listen mode) at a Station-Access Point (STA-AP) in order to receive the terminal transmission signal as described above. Then, the smart order device may receive the terminal transmission signal broadcasted from the terminal 20 and acquire access information (e.g., SSID and PW) of the wireless relay device 30 and access information (e.g., IP and port) of the service server 40 from the received terminal transmission signal.

Moreover, when the access information (e.g., SSID and PW) of the wireless relay device 30 and the access information (e.g., IP and port) of the service server 40 are identified from the terminal transmission signal, the smart order device 10 transmits a device transmission signal including device identification information (MAC or serial No.) of the smart order device 10 in operation S14, to enable the terminal 20 having received the device transmission signal to previously process device registration for the smart order device 10 in the service server 40.

In this regard, when device identification information (MAC or serial No.) of the smart order device 10 is identified from the device transmission signal received from the smart order device 10 in operation S15, the terminal 20 pre-processes device registration for the smart order device 10 in operation S16.

When receiving a device transmission signal broadcasted from the smart order device 10, the terminal 20 obtains device identification information (MAC or serial No.) of the smart order device 10 from the device transmission signal, maps terminal identification information (e.g., APP ID) of the terminal 20 to the obtained device identification information (MAC or serial No.) of the smart order device 10, and registers the mapped information in the service server 40. In this way, the terminal may pre-process device registration for the smart order device 10.

Further, when transmission of the device transmission signal is completed, the smart order device 10 accesses the wireless relay device 30 using the access information (e.g., SSID and PW) of the wireless relay device 30 in operation S17 and accesses the service server 40 through the wireless relay device 30, using the access information (e.g., IP and port) of the service server 40, so as to complete the device registration in operation S18.

Specifically, the smart order device 10 transmits the identification information (MAC or serial No.) of the smart order device 10 to the service server 40, to enable the service server 40 to complete device registration by determining whether the device identification information (MAC or serial No.) of the smart order device 10 received from the smart order device 10 coincides with the device identification information mapped and registered in the terminal identification information of the terminal 20 according to the pre-processing of device registration.

Thereafter, in operation S19, when a user request (button input) through the selection unit 16 is identified, the processor 13 transmits an instant product purchase request including the device identification information (MAC or serial No.) of the smart order device 10 to the service server 40, to enable the service server 40 to process instant product purchasing including purchase, payment, and delivery of a product mapped to the device identification information (MAC or serial No.) of the smart order device 10.

Following the above description about a flow of operations of a smart order system according to an embodiment of the present disclosure, a flow of operations in the smart order device 10 will be described hereinafter.

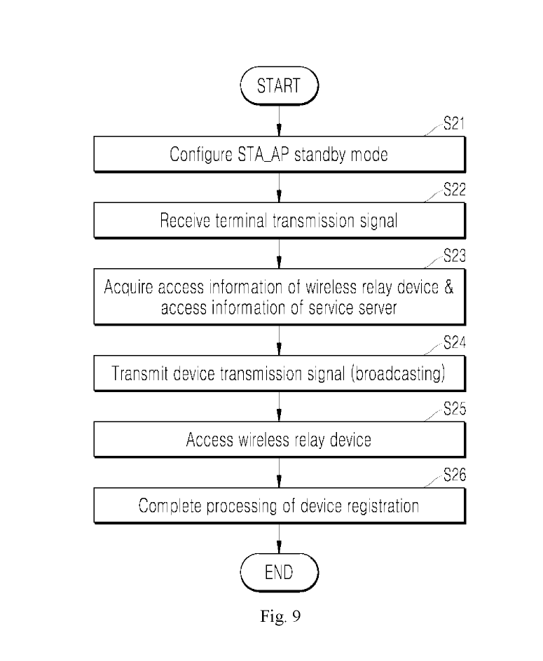

FIG. 9 illustrates an operation flow in a smart order device 10 according to an embodiment of the present disclosure.

First, in response to a request for device registration for the smart order device 10, the acquisition unit 11 acquires, in operations S21 to S23, access information (e.g., SSID and PW) of the wireless relay device 30 and access information (e.g., IP and port) of the service server 40 from a terminal transmission signal received from the terminal 20.

The acquisition unit 11 configures the operation mode of the smart order device 10 into a standby mode (listen mode) at a Station-Access Point (STA-AP) in order to receive the terminal transmission signal as described above. Then, the acquisition unit receives the terminal transmission signal broadcasted from the terminal 20 and acquires access information (e.g., SSID and PW) of the wireless relay device 30 and access information (e.g., IP and port) of the service server 40 from the received terminal transmission signal.

In this regard, when it is identified that device registration for the smart order device 10 is required, the terminal 20 may transmit, in a broadcasting manner, a terminal transmission signal including access information (e.g., SSID and PW) of the wireless relay device 30 and access information (e.g., IP and port) of the service server 40.

Thereafter, when the access information (e.g., SSID and PW) of the wireless relay device 30 and the access information (e.g., IP and port) of the service server 40 are identified from the terminal transmission signal, the transmission unit 12 transmits a device transmission signal including device identification information (MAC or serial No.) of the smart order device 10 in operation S24, to enable the terminal 20 having received the device transmission signal to previously process device registration for the smart order device 10 in the service server 40.

Like the terminal transmission signal, the device transmission signal refers to a UDP signal transmitted in a broadcasting manner.

When receiving a device transmission signal broadcasted from the smart order device 10, the terminal 20 obtains device identification information (MAC or serial No.) of the smart order device 10 from the device transmission signal, maps terminal identification information (e.g., APP ID) of the terminal 20 to the obtained device identification information (MAC or serial No.) of the smart order device 10, and registers the mapped information in the service server 40. In this way, the terminal may pre-process device registration for the smart order device 10.

Thereafter, when transmission of the device transmission signal is completed, the processor 13 accesses the wireless relay device 30 using the access information (e.g., SSID and PW) of the wireless relay device 30 and accesses the service server 40 through the wireless relay device 30, using the access information (e.g., IP and port) of the service server 40, so as to complete the device registration for the smart order device 10, in operations S25 and S26.

Specifically, the processor 13 may configure the operation mode of the smart order device 10 into an access mode at an STA-AP, so as to access the wireless relay device 30 and complete the device registration.

Further, the processor 13 transmits the identification information (MAC or serial No.) of the smart order device 10 to the service server 40, to enable the service server 40 to complete device registration by determining whether the device identification information (MAC or serial No.) of the smart order device 10 received from the smart order device 10 coincides with the device identification information mapped and registered in the terminal identification information of the terminal 20 according to the pre-processing of device registration.

When the device registration for the smart order device 10 is completed, the service server 40 may notify the smart order device 10 through the wireless relay device 30 that the device registration has been completed.

Following the above description about a flow of operations of the smart order device 10 according to an embodiment of the present disclosure, a flow of operations in the terminal 20 will be described hereinafter.

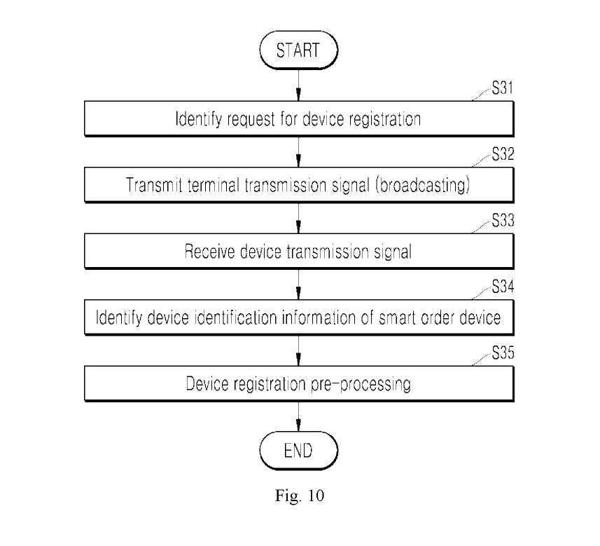

FIG. 10 illustrates an operation flow in a terminal 20 according to an embodiment of the present disclosure.

First, when it is identified in operation S31 that device registration for the smart order device 10 is required, the transmission unit 21 transmits a terminal transmission signal including access information (e.g., SSID and PW) of the wireless relay device 30 and access information (e.g., IP and port) of the service server 40 in operation S32.

The transmission unit 21 transmits the terminal transmission signal, which is a UDP signal, in the broadcasting manner.

In this regard, the smart order device 10 may configure the operation mode of the smart order device 10 into a standby mode (listen mode) at a Station-Access Point (STA-AP) in order to receive the terminal transmission signal as described above. Then, the smart order device may receive the terminal transmission signal broadcasted from the terminal 20 and acquire access information (e.g., SSID and PW) of the wireless relay device 30 and access information (e.g., IP and port) of the service server 40 from the received terminal transmission signal.

Thereafter, after the terminal transmission signal is transmitted, when device identification information (MAC or serial No.) of the smart order device 10 is identified from the device transmission signal received from the smart order device 10, the processor 22 pre-processes device registration for the smart order device 10 in operations S33 to S35.

When receiving a device transmission signal broadcasted from the smart order device 10, the processor 22 obtains device identification information (MAC or serial No.) of the smart order device 10 from the device transmission signal, maps terminal identification information (e.g., APP ID) of the terminal 20 to the obtained device identification information (MAC or serial No.) of the smart order device 10, and registers the mapped information in the service server 40. In this way, the terminal may pre-process device registration for the smart order device 10.

When the pre-processing of device registration for the smart order device 10 is completed, the processor 22 may notify the smart order device 10, through a separate terminal transmission signal, that pre-processing of the device registration has been completed.

In this regard, when the access information (e.g., SSID and PW) of the wireless relay device 30 and the access information (e.g., IP and port) of the service server 40 are identified from the terminal transmission signal, the smart order device 10 transmits a device transmission signal including device identification information (MAC or serial No.) of the smart order device 10 to enable the terminal 20 having received the device transmission signal to previously process device registration for the smart order device 10 in the service server 40.

Like the terminal transmission signal, the device transmission signal refers to a UDP signal transmitted in a broadcasting manner.

Further, when transmission of the device transmission signal is completed, the smart order device 10 accesses the wireless relay device 30 using the access information (e.g., SSID and PW) of the wireless relay device 30 and accesses the service server 40 through the wireless relay device 30, using the access information (e.g., IP and port) of the service server 40, so as to complete the device registration.

As noted from the above discussion, in a process of user configuration required for use of a smart order device 10 based on an IoT device implemented to enable instant product purchasing by means of only a button input, the above-described operation flow within a smart order system according to an embodiment of the present disclosure enables signal processing in a broadcasting manner between the smart order device 10 and the terminal 20 in a state in which the operation mode of the smart order device is maintained. Therefore, the present disclosure can remarkably shorten the time required for the user configuration and thus can enhance the user's satisfaction.

The implementations of the functional operations and subject matter described in the present disclosure may be realized by a digital electronic circuit, by the structure described in the present disclosure and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor unit, a computer, or all kinds of mechanisms, devices, and machines for data processing, including a multiprocessor unit and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

Implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should not be understood that the operations are performed in the shown specific sequence or that all shown operations are performed in order to obtain a preferable result. In a specific case, a multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

A smart order device, an operation method thereof, and a user terminal according to the present disclosure can simplify a process of user configuration required for use of the smart order device based on an IoT device implemented to enable instant product purchasing by means of only a button input. In this regard, the present disclosure overcomes the technical limit of the prior art. Moreover, the present disclosure not only allows technologies related thereto to be used, but also has sufficient probability that applied devices thereof can be marketed or circulated. Therefore, the present disclosure can be obviously carried out and is thus industrially applicable.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A smart order device comprising:
a processor configured to perform a process for device registration in a service server; and
a memory configured to store processor-executable instructions that, when executed by the processor, cause the processor to:
in response to a request for device registration for the smart order device, acquire access information of a wireless relay device and access information of the service server from a terminal transmission signal transmitted from a terminal;
transmit device transmission signal including device identification information of the smart order device to enable the terminal to pre-process device registration for the smart order device in the service server, wherein the terminal is configured to identify the device identification information of the smart order device from the device transmission signal; and
process device registration for the smart order device by accessing the wireless relay device based on the access information of the wireless relay device and by accessing the service server, through the wireless relay device, based on the access information of the service server.

2. The smart order device of claim 1, wherein the process-executable instructions, when executed by the processor, further cause the processor to:
set the operation mode of the smart order device into a standby mode at a Station-Access Point (STA-AP) to enable the access information of the wireless relay device to be acquired from the terminal transmission signal; and
set the operation mode of the smart order device into an access mode at the STA-AP to enable an access to the wireless relay device.

3. The smart order device of claim 1, wherein at least one of the terminal transmission signal or the device transmission signal comprises a User Datagram Protocol (UDP) signal transmitted in a broadcasting manner.

4. The smart order device of claim 1, wherein, in pre-processing the device registration for the smart order device, terminal identification information of the terminal is mapped to device identification information of the smart order device, and mapped information is then registered in the service server.

5. The smart order device of claim 4, wherein the process-executable instructions, when executed by the processor, cause the processor to access information of the wireless relay device to the service server through the wireless relay device.

6. The smart order device of claim 5, wherein, in completing the device registration for the smart order device, the service server is configured to determine whether the device identification information mapped to terminal identification information of the terminal coincides with the device identification information of the smart order device received from the smart order device according to the process command.

7. A terminal comprising:
a processor configured to perform a process associated with a smart order device; and
a memory configure to store processor-executable instructions that, when executed by the processor, cause the processor to:
when device registration for the smart order device is required, transmit a terminal transmission signal to enable a smart order device to acquire access information of the wireless relay device and access information of the service server from the terminal transmission signal;
identify device identification information of the smart order device from a device transmission signal received from the smart order device receiving the terminal transmission signal; and
pre-process the device registration for the smart order device in the service server.

8. The terminal of claim 7, wherein the terminal transmission signal comprises a UDP signal transmitted in a broadcasting manner, and wherein the smart order device is configured to acquire the access information of the wireless relay device from the terminal transmission signal in a standby mode at a Station-Access Point (STA-AP).

9. An operation method of a smart order device, the method comprising:
acquiring access information of a wireless relay device and access information of a service server from a terminal transmission signal transmitted from a terminal;
transmitting device transmission signal including device identification information of the smart order device to enable the terminal to pre-process device registration for the smart order device in the service server, wherein the terminal is configured to identify the device identification information of the smart order device from the device transmission signal; and
processing device registration for the smart order device by accessing the wireless relay device based on the access information of the wireless relay device and by accessing the service server, through the wireless relay device, based on the access information of the service server.

10. The method of claim 9, wherein:
acquiring the access information comprises setting the operation mode of the smart order device into a standby mode at a Station-Access Point (STA-AP) to enable the access information of the wireless relay device to be acquired from the terminal transmission signal, and
processing the device registration for the smart order device comprises setting the operation mode of the smart order device into an access mode at the STA-AP to enable an access to the wireless relay device.

11. The method of claim 9, wherein at least one of the terminal transmission signal or the device transmission signal comprises a User Datagram Protocol (UDP) signal transmitted in a broadcasting manner.

12. The method of claim 9, wherein pre-processing the device registration for the smart order device comprises:
mapping terminal identification information of the terminal to the device identification information of the smart order device; and
registering the terminal identification information of the terminal in the service server.

13. The method of claim 12, wherein processing the device registration for the smart order device comprises:
transmitting the access information of the wireless relay device to the service server through the wireless relay device.

14. The method of claim 13, wherein processing the device registration for the smart order device comprises:
determining, by the service server, whether the device identification information mapped to terminal identification information of the terminal coincides with the device identification information of the smart order device received from the smart order device.
